(19) United States
(12) Patent Application Publication
(10) Pub. No.: US 2008/0316093 A1
(43) Pub. Date: Dec. 25, 2008

(54) GPS global coverage augmentation system

(76) Inventors: Marvin D. Swensen, Fullerton, CA (US); John G. Himes, Placentia, CA (US)

Correspondence Address: DICKSTEIN SHAPIRO LLP, 1825 EYE STREET NW, Washington, DC, 20006-5403, US

(21) Appl. No.: 11/819,115

(22) Filed: Jun. 25, 2007

(51) Int. Cl. H04B 7/185

(52) U.S. Cl. 342/357.03

(57) ABSTRACT

A method and apparatus for efficiently obtaining improved coverage in augmenting GPS position location with differential GPS integrity and correction messages using existing satellite systems, planned satellite systems, or a combination of both to broadcast these integrity and correction messages without requiring dedicated satellite resources. At least one existing satellite system offers full global coverage whereas the conventional approach of disseminating these integrity and correction messages using geostationary satellites necessarily omits Polar Regions. This existing satellite system also provides redundant coverage globally whereas the conventional approach using geostationary satellites must increase the number of geostationary satellites in direct proportion to the level of redundancy desired. At least one other existing satellite-based system offers higher availability (i.e., more geographically complete) coverage with these integrity and correction message by also employing ground-based transmitters to gain three way redundant coverage. Using existing or planned satellite systems to broadcast differential GPS integrity and correction messages also eliminates the expense and delays associated with building and launching either dedicated geostationary satellites or dedicated satellite payloads on host satellites. Using available satellite resources also enables cost efficient customization of disseminated integrity and correction messages. The apparatus comprises a set of ground reference stations with individual assigned geographic spaces, a master station that gathers integrity and correction messages from these ground reference stations and transmits them to a satellite-based system or systems that broadcast integrity and correction messages, possibly customized, and users with equipment capable of receiving signals from the satellite system.

### FIELD OF THE INVENTION

The present invention offers a novel means, without requiring either dedicated satellites or dedicated satellite resources, to obtain full global coverage, or higher availability regional coverage, or more flexible message dissemination for providing GPS users with augmentation information that improves the accuracy of their position determination.

### BACKGROUND OF THE INVENTION

Locating mobile platforms is vital for many applications and consequently attracts much attention. Radio-based positioning or use of radio waves to locate mobile platforms includes both non-cooperative techniques (e.g., radar) and cooperative techniques wherein mobile platforms receive only, transmit only, or both receive and transmit, e.g., the Global Positioning System (GPS), Teletrac, or the Enhanced Position Location and Reporting Systems (EPLRS), respectively.

All of these radio-based positioning techniques rely on radio wave propagation time between transmitter and receiver. Most systems based on these techniques employ reference sites with fixed, known geolocations as a basis for locating mobile platforms. But some systems use mobile reference platforms with locations separately determined, e.g., state of the art literature describes a means for determining locations for satellite reference platforms used in a positioning system such as GPS.

Each GPS user (mobile platform) makes simultaneous or nearly-simultaneous time-of-arrival measurements on signals arriving from at least four different GPS satellites. These measurements resolve unknown user platform parameters (px, py, pz and t) because satellite ephemeris are approximately known and GPS satellites are synchronized (i.e., their relative clock offsets are known).

GPS as presently deployed is successful but the system exhibits shortcomings that affect the accuracy of position calculations. For example, GPS position measurements experience slowly varying errors due to satellite orbit discrepancies, satellite clock drift, and ionospheric disturbances. Principal among these are ionospheric disturbances, which vary greatly over wide areas, making them difficult to correct with standard GPS receivers.

Thus, specialized GPS receivers are necessary to perform highly accurate GPS-related position determinations, also called geodetic determinations. These specialized receivers make GPS position measurements but also rely on integrity and correction messages developed at reference stations by systems, collectively designated as Differential GPS, to improve the accuracy of the position measurements. Examples of Differential GPS systems are the Radio Technical Commission for Maritime Services provided by the United States Coast Guard, and the Australian Maritime Safety Authority, each of which provides Differential GPS correction signals primarily intended for maritime users.

Differential GPS assumes that a stationary GPS receiver located at the reference station and other nearby GPS receivers will encounter similar errors. The stationary receiver at the reference station measures the GPS signal error by comparing its location as derived from GPS signals to its exact, known location a priori determined by a precise survey. The reference receiver makes its timing error measurements available to other specialized GPS receivers that allow them to correct for errors and thereby obtain a more accurate position measurement.

Another Differential GPS implementation, the FAA's Wide Area Augmentation System (WAAS), provides differential integrity and correction messages as well as additional ranging signals for users anywhere in the contiguous United States. WAAS uses a network of twenty-five (25) ground reference stations across CONUS and two (2) master stations, which are linked together, to develop differential integrity and correction messages suitable for use across all of CONUS. In Japan, the MTSAT Satellite-based Augmentation System (MSAS) provides similar service. Both WAAS and MSAS employ dedicated transponders on host satellites to disseminate differential integrity and correction messages.

Because differential GPS was not developed as an integral constituent of GPS itself, GPS satellites have no means for providing integrity and correction messages to users. Hence a means for distributing these corrections messages to users is necessary.

WAAS master stations transmit integrity and correction messages to two geostationary satellites hosting dedicated WAAS transponders. A GPS receiver, customized to receive WAAS integrity and correction messages, when located within the coverage areas of these WAAS geostationary satellites, can receive said WAAS integrity and correction messages transmitted from one or both of these satellites. MSAS also operates in the same fashion, using dedicated MSAS transponders carried by two host satellites.

If multiple geostationary WAAS satellites become available as sources of integrity and correction messages, this customized GPS receiver, when positioned within the coverage area of these WAAS satellites, can receive WAAS integrity and correction messages transmitted from one or more of these multiple satellites.

The WAAS/MSAS approach to disseminating integrity and correction messages has inherent coverage limitations. It does not support users in polar regions (greater than 70° longitude) because of limitations inherent in geostationary coverage. It also exhibits poor performance in areas such as urban canyons where satellite reception often experiences blockages.

In addition, this approach requires deployment of additional geostationary satellites over areas other than CONUS to achieve worldwide coverage, exclusive of the aforementioned polar regions. If a WAAS/MSAS—like approach intends that users have access to integrity and correction signals from multiple geostationary satellites, then the number of geostationary satellites required, and hence cost thereof, rises in proportion to the desired level of redundancy.

It can be seen, then, that there is a need in the art for an independent system for transmitting differential integrity and correction messages to GPS users that cost effectively achieves global coverage and higher availability regional coverage with appropriate redundancy.

Related Art Approaches

Typical approaches use GPS-based receivers and additional information, such as MSAS differential GPS integrity and correction messages, to increase the reliability and accuracy of GPS-based position location measurements. However, these systems rely on dedicated resources, achieve neither global coverage nor highly redundant (high geographic availability) coverage, require lengthy and costly deployment, and admit no message customization.

Related United States Patent Documents

Several other inventions provide methods, apparatus, techniques or systems for augmenting GPS as described in the following patents. Among them are

| | | | |
|---|---|---|---|
| 7164383 | 16 Jan. 2007 | Fagan et al | Navigation System Using |
| | | | Locally Augmented GPS |
| 7117417 | 3 Oct. 2006 | Sharpe et al | Method for Generating Clock |
| | | | Corrections for a Wide-Area or |
| | | | Global Differential GPS System |
| 7110883 | 19 Sep. 2006 | Pemble et al | Space Based Augmentation |
| | | | System with Hierarchy for |
| | | | Determining Geographical |
| | | | Corrections Source |
| 6961018 | 1 Nov. 2005 | Heppe et al | Method and Apparatus for |
| | | | Satellite-Based Relative |
| | | | Positioning of Moving Platforms |
| 6862526 | 1 Mar. 2005 | Robbins | GPS Correction Method, |
| | | | Apparatus and Signals |
| 6839631 | 4 Jan. 2005 | Pemble et al | Space Based Augmentation |
| | | | System with Hierarchy for |
| | | | Determining Geographical |
| | | | Corrections Source |
| 6531981 | 11 Mar. 2003 | Fuller et al | Global Augmentation to |
| | | | Global Positioning System |
| 6469663 | 22 Oct. 2002 | Whitehead et al | Method and System for GPS and |
| | | | WAAS Carrier Phase Measurements |
| | | | for Relative Positioning |
| 20060214844 | 28 Sep. 2006 | Fagan et al | Navigation System Using |
| | | | External Monitoring |

Referenced patents and patent applications include enhancements to differential GPS correction systems. U.S. Pat. Nos. 7,110,883 and 6,839,631, describe a method for choosing integrity and correction messages when multiple satellite signals are available; U.S. Pat. Nos. 7,164,383 and 6,862,526 and patent application 20060214844 describe use of local reference stations to better refine and authenticate integrity and correction messages in local area. U.S. Pat. No. 6,531,981 combines both wide-area and local area integrity and correction messages. U.S. Pat. No. 6,961,018 extends differential correction techniques to relative positioning between moving platforms. U.S. Pat. Nos. 7,117,417 and 6,469,663 enhance differential correction techniques with carrier phase information or dual frequency measurements.

The invention described herein is distinct from each and any of the inventions discussed in this subsection because it describes an innovative means for wide-area (up to and including global) broadcast of integrity and correction messages and/or customized message dissemination, using either existing or planned satellite systems without any resources dedicated specifically to dissemination of these messages.

### SUMMARY OF THE INVENTION

Transmission of differential GPS integrity and correction messages to GPS users who desire more accurate position determination than provided by GPS can occur by means other than dedicated satellite-based systems such as WAAS or MSAS. Use of existing satellite systems such as Iridium or Globalstar, or other planned satellite systems offers global coverage with redundancy and high availability but does not require dedicated satellite resources. Use of existing satellite systems such as XM Satellite Radio, Worldspace, Thuraya, ACES or Sirius, or other planned satellite systems offers improved regional coverage with redundancy and high availability but also does not require dedicated satellite resources. In addition, all existing satellite systems cited provide data rates far in excess of that necessary for dissemination of differential GPS integrity and correction messages. Hence use of existing satellite system resources admits flexibility in drawing on these resources to customize dissemination to specific user groups or in specific situations, i.e., in a time varying manner.

The present invention comprises a method and system for providing differential integrity and correction messages to GPS users globally, with higher availability regionally, or with customized content. A system in accordance with the current invention comprises a set of ground reference stations, a master station that gathers error messages or integrity and correction messages from these ground reference stations, a satellite system that broadcasts integrity and correction messages, and users with equipment capable of receiving signals from the satellite system. The satellite system and, in some regions the ground reference stations and user equipment, are not dedicated resources, greatly reducing implementation cost of the invention.

As the system can also comprise more than one ground reference station with each assigned to a separate geographic space, mobile users may encounter transition zones, wherein a transition zone comprises the overlap of at least two of the geographic spaces. When the mobile user is in a transition zone, the mobile user may receive more than one integrity and correction message. The mobile user may choose to combine multiple integrity and correction messages to develop an integrity and correction message tailored to the overlap region.

The method may also include: (1) users equipped with separate equipment capable of receiving the integrity and correction messages from one or more satellite systems, i.e., a terminal suitable for use with one or more of the satellite systems, (2) users equipped with customized GPS equipment capable of also receiving the integrity and correction messages from one or more satellite systems.

The method may have considerable flexibility in dissemination of integrity and correction messages wherein message dissemination is customized for specific users or specific situations, by utilizing more of the satellite system resources or satellite system resources. This tailored use of satellite resources is cost efficient because it draws upon satellite resources only when necessary.

The method may comprise each ground reference station developing an integrity and correction message for its assigned geographic space, the master station gathering integrity and correction messages from the ground reference stations and transmitting integrity and correction messages to the satellite system broadcasting integrity and correction messages to users equipped to receive the integrity and correction messages, i.e., with a terminal suitable for use with the satellite system. These ground reference stations develop integrity and correction messages that include geographic spaces spanning the entire globe or any portions thereof.

The method may also include one or more ground reference stations developing an error message for its assigned geographic space, the master station gathering error messages from these ground reference stations, and the master station preparing integrity and correction messages for the ground reference stations that develop only error messages. These ground reference stations develop error messages that include geographic spaces spanning the entire globe or any portions thereof.

The method may also include use of one or more additional stations with capability equivalent to the master station as backups or, if desired, operating in parallel to bring redundancy to the entire system. Some satellite-based systems may require multiple ground stations whereas others will use cross-links between satellites to distribute a global set of integrity and correction messages.

The method may also include the master station transmitting integrity and correction messages to more than one satellite system broadcasting integrity and correction messages to users equipped to receive the integrity and correction messages.

The method may also include customized dissemination of integrity and correction messages wherein some integrity and correction messages are tailored for specific users based on user attributes such as geographic location or for specific situations, but rendered unavailable to other users by reliance on passwords or other known security techniques such as those in use by systems such as DirecTV. Use of satellite systems not dedicated to differential GPS message dissemination offers vastly more capacity than dedicated systems such as MSAS provide and, hence, offers the ability to customize messages by user groups or temporally.

The method may also include ground reference stations that monitor the quality of disseminated integrity and correction messages, and provide error signals or quality metrics about these messages to the master station. Master stations can use these quality measures to establish signal parameters for messages disseminated over these satellite-based systems. Those users that access multiple systems can use algorithms involving such quality measures to combine the integrity and correction messages they receive.

### BRIEF DESCRIPTION OF THE DRAWINGS

Referring now to the drawings in which like reference numbers represent corresponding parts throughout:

FIG. 1 illustrates an existing satellite system (using Iridium as an example for illustrative purposes, although Globalstar can also support) that offers global coverage with high availability, redundancy and global coverage;

FIG. 2 illustrates an implementation in accordance with the present invention that takes advantage of existing ground infrastructure (using WAAS as an example for illustrative purposes although any ground infrastructure, existing or planned, that provides differential GPS integrity and correction messages can support this implementation);

FIG. 3 illustrates the regional markets, including polar regions, for this invention, and;

FIG. 4 illustrates an implementation in accordance with the present invention that provides its own reference and master station as no infrastructure yet exists.

### DETAILED DESCRIPTION OF THE PREFERRED EMBODIMENT

In the following description of the preferred embodiment, reference is made to the accompanying drawings, which form a part hereof, and in which is shown by way of illustration a specific embodiment in which the invention may be practiced. It is to be understood that other embodiments may be utilized and structural changes may be made without departing from the scope of the present invention.

Overview

There are at least two satellite systems, Iridium and Globalstar, that can broadcast integrity and correction messages to any GPS-user capable of receiving their signals. These systems offer global coverage, redundant coverage, high availability, and increased flexibility to their users.

There are at least four geosynchronous satellite systems, Thuraya, ACES, XM Satellite Radio, and Worldspace Satellite Radio, that can broadcast integrity and correction messages, albeit with only regional coverage, to any GPS-user also capable of receiving their signals. These systems also offer redundant coverage, high availability and increased flexibility to their users. Moreover their regional coverages are distinct so users can benefit from engaging with multiple systems. In addition, XM Satellite Radio and WorldSpace Satellite Radio offer a third level of redundant coverage using a network of ground transmitters that greatly increase signal availability in areas, primarily urban, where satellite-based coverage has proved to be inadequate.

There is at least one non-geosynchronous satellite systems, Sirius Satellite Radio, that can broadcast integrity and correction messages, albeit with only regional coverage, to any GPS-user also capable of receiving their signals. This system offers redundant coverage, high availability and increased flexibility to their users.

Each of the aforementioned satellite systems is already operational (a complete ground infrastructure and a full complement of on-orbit satellites). Each system has also developed inexpensive terminal equipment in form factors that users find convenient. Service providing differential integrity and correction messages with any combination of these systems can commence rapidly as opposed to developing dedicated infrastructure including satellites, as was the case with both WAAS and MSAS.

Further, where a ground infrastructure for providing differential integrity and correction messages already exists, this invention can re-use this infrastructure. For example, it can re-use the MSAS ground reference stations or the MSAS master station or both to provide integrity and correction messages to the master station that transmits them to the satellite system or systems being used for dissemination.

System Overview

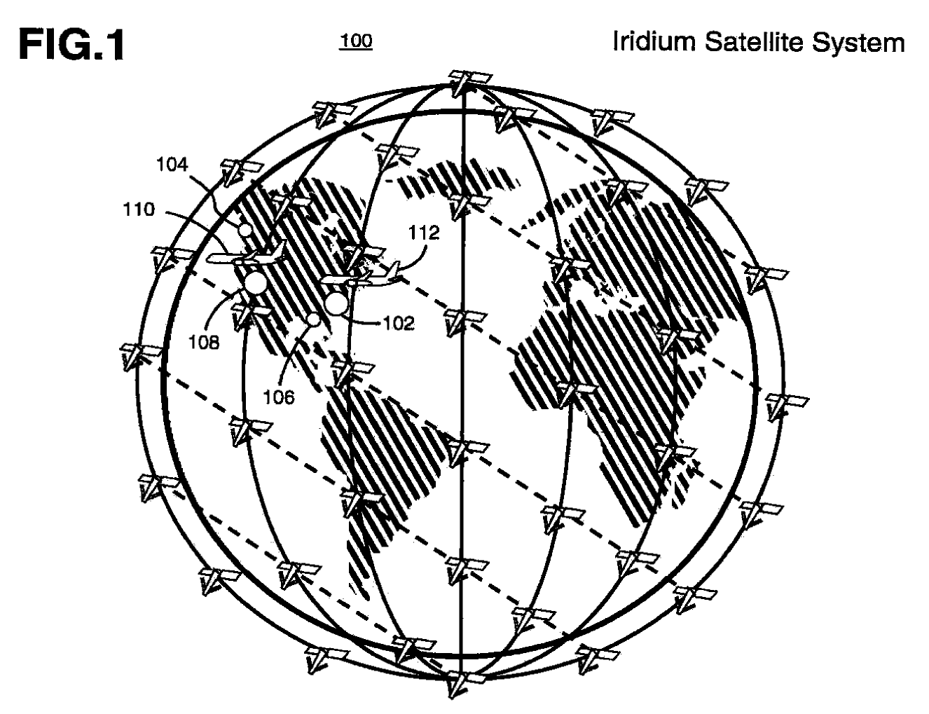

FIG. 1 illustrates a typical satellite system 100 that can broadcast integrity and correction messages to users anywhere on earth. FIG. 1 depicts Iridium but other satellite systems such as Globalstar also can broadcast integrity and correction messages globally. Master Station 102 collects error messages or integrity and correction messages from ground reference stations such as 104 and 106. Master station 102 transmits the integrity and correction messages to the satellite system 100. A backup master station 108 provides redundancy for master station 102. There may be a smaller or a larger number of ground reference stations; the number shown in FIG. 1 is merely for purposes of illustration and not limiting of the present invention. Although a single master station now controls and operates the entire Iridium constellation, there may also be additional master stations or backups for master stations. There may also be additional satellite systems broadcasting integrity and correction messages.

Users 110, 112 must be able to receive integrity and correction messages from satellite system 100. By regularly receiving integrity and correction messages, users 110, 112 ensure that their GPS position locations are enhanced. There may be a smaller or a larger number of users; the number shown in FIG. 1 is merely for purposes of illustration and not limiting of the present invention.

Infrastructure Re-Use

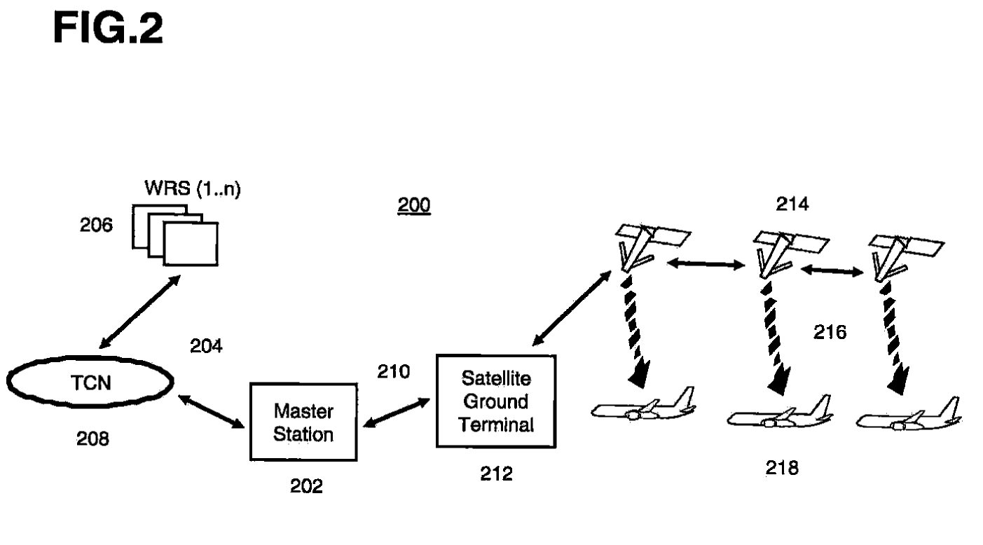

FIG. 2 illustrates re-use of an existing ground infrastructure 200 in accordance with the present invention. For purposes of illustration, WAAS serves as an example of a supporting ground infrastructure but any DGPS ground infrastructure, existing or planned, can provide the differential integrity/correction data for use with this invention. Herein the master station 202 uses integrity and correction messages 204 developed by ground references stations 206 and made available through the WAAS TCN 208 as its data source.

The master station 202 provides an uplink signal 210 for transmission to the satellite, using its own ground terminal 212 matched to the satellite system 214 that broadcasts the correction/integrity message 216 to users 218. FIG. 2 depicts the Iridium constellation but other satellite systems such as Globalstar also can broadcast integrity and correction messages. There may be a different ground infrastructure or multiple ground infrastructures; the number shown in FIG. 2 is merely for purposes of illustration and not limiting of the present invention.

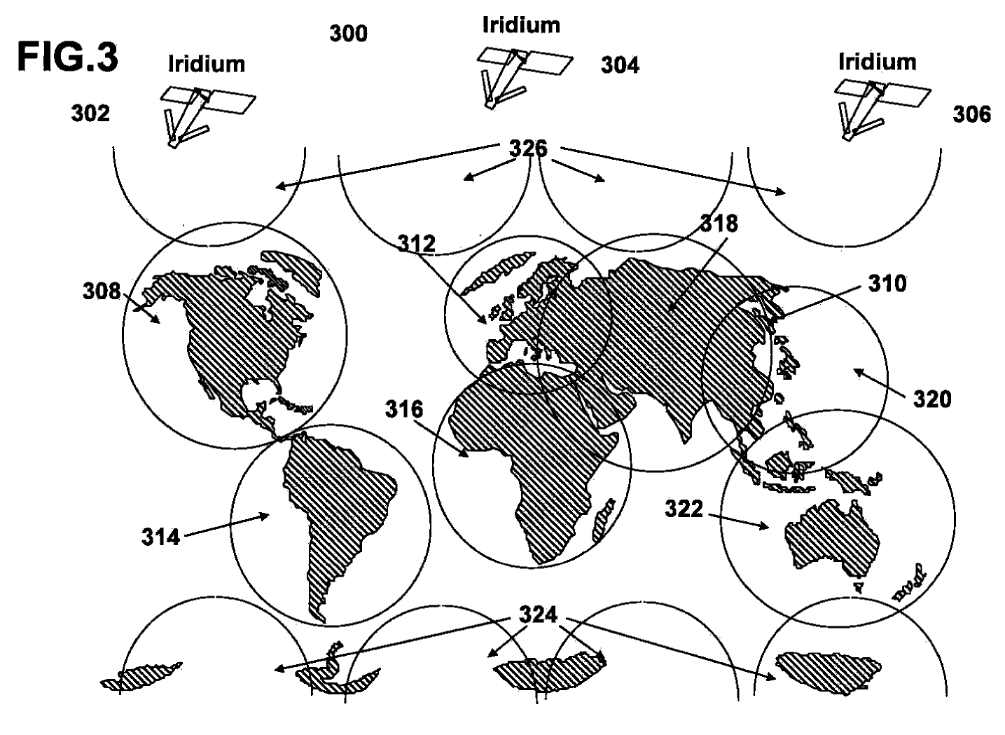

FIG. 3 illustrates how this system is applicable globally. The system 300 uses the Iridium satellites 302, 304, 306 for global dissemination. It is compatible with the ground infrastructures in existing regional wide-area augmentation systems such as WAAS 308 and MSAS 310, the infrastructures of planned wide-area augmentation systems such as the European Geostationary Navigation Overlay Service (EGNOS) 312, and it also can be deployed along with its own ground infrastructure into areas lacking ground infrastructures such as South America 314, Africa 316, East Europe 318, Asia excepting Japan 320 and the South Pacific 322. Moreover it can accept or develop integrity and correction messages from every one of these areas and more at the same time because its broadcast extends globally including polar areas such as 324, 326 (shown disjoint) and mid-oceanic regions not serviced by the regional wide-area augmentation systems shown in FIG. 3.

Infrastructure Deployment

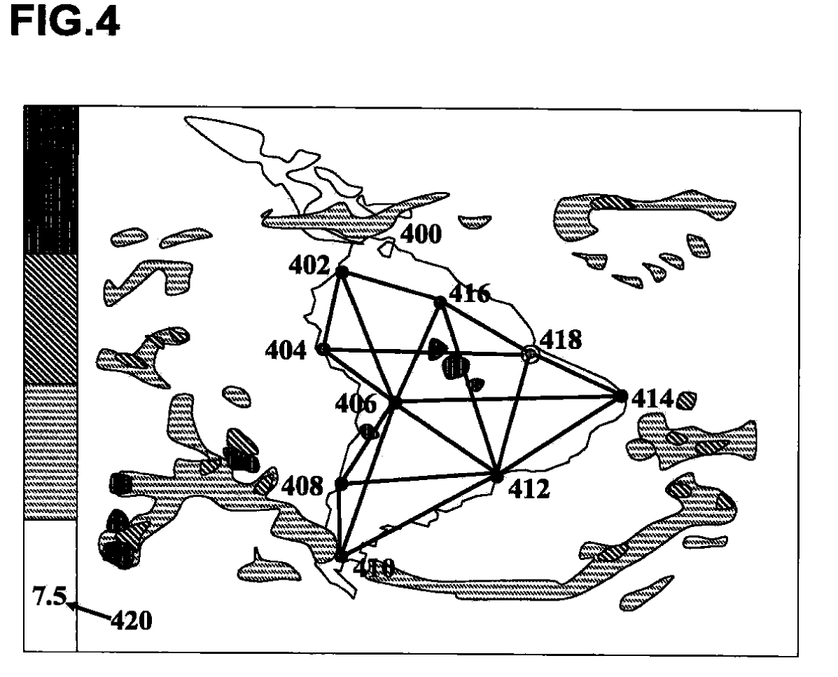

FIG. 4 shows how this system may deploy its own ground infrastructure in regions where there is no existing or planned infrastructure, such as South America 400. In this region, 8 ground reference stations 402, 404, 406, 408, 410, 412, 414, and 416 and one master station 418 provide enough capability to enable users to achieve the distribution of errors in vertical accuracy 420 shown color-coded in FIG. 4 more than 95% of the time.

The foregoing description of the preferred embodiment of the invention has been presented for the purposes of illustration and description. It is not intended to be exhaustive or to limit the invention to the precise form disclosed. Many modifications and variations are possible in light of the above teaching.

It is intended that the scope of the invention be limited not by this detailed description, but rather by the claims included herein. The above specification, examples and data provide a complete description of the manufacture and use of the apparatus and method of the invention. Since many embodiments of the invention can be made without departing from the scope of the invention, the invention resides in the claims herein and the equivalents thereto.

1. A system for obtaining full global coverage and/or higher availability regional coverage (henceforth improved coverage) in differential GPS integrity and correction message dissemination comprising:
a set of ground reference stations with individual assigned geographic spaces;
a master station that gathers integrity and correction messages from the ground reference stations, processes the messages, and transmits the messages to an existing satellite-based system that broadcasts the messages to users;
a ground-based relay system that receives and rebroadcasts the messages; and
user equipment capable of receiving signals bearing these messages from the existing satellite-based system and the ground-based relay system,
wherein the existing satellite-based system is reused as-is without dedicated satellites or dedicated resources hosted on satellites.

2. The improved coverage differential GPS integrity and correction message dissemination system of claim 1, further comprising at least one additional space system, whether already existing or planned, for broadcasting differential GPS integrity and correction messages.

3. (canceled)

4. The improved coverage differential GPS integrity and correction message dissemination system of claim 2, wherein the user equipment is customized to receive signals from the satellite system, including the associated ground-based relay system.

5. The improved coverage differential GPS integrity and correction message dissemination system of claim 4, wherein the user equipment can receive signals from more than one satellite system.

6. The improved coverage differential GPS integrity and correction message dissemination system of claim 5, wherein the user equipment is customized to also receive GPS signals.

7. A method for obtaining full global coverage and/or higher availability regional coverage (henceforth improved coverage) in differential GPS integrity and correction message dissemination, comprising:
a set of ground reference stations, each developing an integrity and correction message for its assigned geographic space;
a master station gathering integrity and correction messages from the ground reference stations, processing the messages, and transmitting the messages to a satellite system that broadcasts the messages;
a ground-based relay system that receives and rebroadcasts the messages;
user equipment that receives the messages from at least one of the satellite system and the ground-based relay system,
wherein the satellite system is an existing satellite system reused as-is without dedicated satellites or dedicated resources on satellites and providing at least one of global coverage, higher availability regional coverage, and greater flexibility in message dissemination.

8. The method of claim 7, further comprising sending integrity and correction messages to at least one additional satellite system that also broadcasts these integrity and correction messages.

9. The method of claim 8, further comprising one or more additional ground reference stations associated with the at least one additional satellite system that develop error messages for their assigned geographic space, which collectively encompass the entire globe or any portions thereof, for which the master station develops integrity and correction messages.

10. The method of claim 7, wherein the master station transmits on multiple frequencies to the satellite system.

11. The method of claim 7, wherein the user equipment receives integrity and correction signals from multiple satellite systems.

12. (canceled)

13. The method of claim 8, wherein the master station customizes dissemination of integrity and correction messages specific situations, utilizing more or less of the satellite system resources or satellite systems resources.

14. The method of claim 7, wherein ground reference stations monitor signals from existing satellite-based systems to develop additional, non-GPS, integrity and correction messages associated with the existing satellite-based systems.

15. The improved coverage differential GPS integrity and correction message dissemination system of claim 4, wherein the user equipment is customized to also receive GPS signals.

16. The method of claim 11, wherein the user equipment is customized to also receive GPS signals.
